(19) United States
(12) Patent Application Publication
(10) Pub. No.: US 2019/0244154 A1
(43) Pub. Date: Aug. 8, 2019

(54) WORK SUPPORT SYSTEM AND WORK SUPPORT METHOD

(71) Applicant: TOYOTA JIDOSHA KABUSHIKI KAISHA, Toyota-shi (JP)

(72) Inventors: Takahiro MUTA, Mishima-shi (JP); Eisuke ANDO, Nagoya-shi (JP); Takao HISHIKAWA, Nagoya-shi (JP)

(73) Assignee: TOYOTA JIDOSHA KABUSHIKI KAISHA, Toyota-shi (JP)

(21) Appl. No.: 16/261,952

(22) Filed: Jan. 30, 2019

(30) Foreign Application Priority Data
Feb. 6, 2018 (JP) 2018-018758

(51) Int. Cl. G06Q 10/06

(52) U.S. Cl. CPC G06Q 10/063114

(57) ABSTRACT

A work support system is provided for supporting work execution by a user by using an information processing apparatus in a moving body which has the information processing apparatus; the work support system comprising an acquirer configured to acquire first working environment information to be used by the user to restart an interrupted work from a work management apparatus for storing work information in relation to the interrupted work, if the user interrupts the work that has been being executed; and a former configured to form a first working environment for restarting the interrupted work on the basis of the first working environment information in the information processing apparatus possessed by the moving body, if the user moves to a destination by the moving body after the user interrupts the work to be interrupted.

### CROSS REFERENCE TO RELATED APPLICATION

This application claims the benefit of Japanese Patent Application No. 2018-018758, filed on Feb. 6, 2018, which is hereby incorporated by reference herein in its entirety.

### BACKGROUND

### Technical Field

The present disclosure relates to a system and a method for supporting a user to execute a work by using an information processing apparatus in a moving body which has the information processing apparatus.

### Description of the Related Art

In general, the moving body such as a vehicle or the like is used in order that a user moves to a desired destination or in order that a cargo is transported to a desired delivery destination. Further, such a form is also conceived that the space in the vehicle is utilized as a space in which the user performs his/her own work. For example, Patent Document 1 discloses a mobile office which is constructed such that pieces of equipment for business use are arranged usably in vehicles, and the plurality of vehicles are connected to one another. The plurality of vehicles are connected to a connecting vehicle which is provided in order to connect the vehicles. Thus, people can come and go between the vehicles via the connecting vehicle, and an office space, which has an extent as required, is provided. Further, a vehicle, which is arranged with at least one of a power generation apparatus, an air conditioning apparatus, a bathroom, a toilet, and pieces of kitchen equipment, is connected to the connecting vehicle, and thus the comfortability or liveability of the office is enhanced. Note that the mobile office of Patent Document 1 is constructed such that a plurality of vehicles and a connecting vehicle are gathered at a predetermined place, and they are connected to one another at the place.

### Preceding Technical Document

### Patent Document

### [Patent Document 1]

Japanese Patent Application Laid-Open No. 9-183334

### SUMMARY

A situation, which is more emergent than the work that is being executed, occurs in some cases at any place outside the workplace when the user executes his/her work at the workplace. The situation, which is more emergent than the work that is being executed, is, for example, the occurrence of a disease of a member of the family. When such a situation occurs, the user inevitably interrupts the work which is being executed. Further, it is difficult to predict to what extent the emergent situation affects the work schedule thereafter, depending on the content of the emergent situation. On this account, the user needs time to perform succession of the work which is being executed and/or adjust the schedule thereafter, while considering the range of influence. Even when the user accepts the communication of, for example, the disease of the member of the family, it has been difficult for the user to interrupt the work and immediately go to the place outside the workplace.

The present disclosure has been made taking various actual circumstances as described above into consideration, an object of which is to provide a technique for securing the continuity of a work even when a user interrupts the work and leaves a workplace.

In order to solve the problem as described above, the present applicant has so contrived that when a user interrupts a work which is being executed, a working environment for the interrupted work is formed in an information processing apparatus possessed by a moving body which is usable for the user to move to a destination.

In particular, the present disclosure resides in a work support system for supporting work execution by a user by using an information processing apparatus in a moving body which has the information processing apparatus; the work support system may comprising an acquirer configured to acquire first working environment information to be used by the user to restart an interrupted work from a work management apparatus for storing work information in relation to the interrupted work, if the user interrupts the work that has been being executed; and a former configured to form a first working environment for restarting the interrupted work on the basis of the first working environment information in the information processing apparatus possessed by the moving body, if the user moves to a destination by the moving body after the user interrupts the work to be interrupted.

The work support system of the present disclosure is a system which supports the user so that the user can continue the interrupted work by utilizing the information processing apparatus provided in the moving body in order that the user moves to the destination such as his/her home or the like, if the user inevitably interrupts the work which is being executed, for example, due to any emergent situation. The emergent situation is, for example, the occurrence of any event such as a disease of a member of the family or the like which is more emergent than the work which is being executed. The moving body is, for example, a vehicle, by which the user is transported to the destination. The destination is a destination of movement when the necessity arises for the user to interrupt the work which is being executed. The information processing apparatus may be an apparatus with which the user, who gets on the moving body, can continue the interrupted work. The information processing apparatus may be arranged while being fixed to any structure disposed on the side of the moving body. Alternatively, the information processing apparatus may be arranged so that the user can freely move the apparatus in the moving body. Further, the information processing apparatus also includes an interface device which is required for the user to execute the interrupted work.

The “work” referred to in this application resides in a concept that includes not only a job or task which is required to be executed by the user at the workplace of a company or the like, but also, for example, an affair which is intended to be executed by the user personally and an affair which is, for example, requested or required by any other person to be executed by the user. That is, the work is an affair which is recognized by the user to be executed in relation to the work. There is no special limitation in relation to, for example, the reason and the background of the execution. The interrupted work is the work which has been being executed and which is inevitably interrupted by the user due to the emergent situation. The work information may include the first working environment information used by the user to restart the interrupted work, and the work information may be information coincident with the first working environment information. The “working environment” referred to in this application refers to such a state that the user can execute the interrupted work with the information processing apparatus possessed by the moving body. The working environment is, for example, an environment in which a file or data having been in execution can be corrected, an environment in which the user can participate in a meeting in session by using a television meeting system and/or another person can converse with the user who executes the work at the workplace, or an environment in which a telephone call addressed to the user can be transferred from the workplace.

In the work support system described above, the acquirer may acquire the first working environment information used by the user to restart the interrupted work, from the work management apparatus. The first working environment information, which is used by the user to restart the interrupted work, may be stored in the work management apparatus. Further, the work management apparatus may store work information relevant to the work of which the user is in charge, in addition to the work which is interrupted by the user.

The former may form the first working environment in the information processing apparatus possessed by the moving body, on the basis of the information for forming the first working environment acquired by the work management apparatus so that the user can restart and continue the interrupted work in the moving body. Accordingly, the user can restart and continue the interrupted work in the moving body which moves to the destination, and it is possible to secure the continuity of the work.

Further, the work information in relation to the interrupted work may include predetermined information for instructing the user to restart the interrupted work in the moving body during a period until the user moves to the destination by the moving body; and the former may form the first working environment in the information processing apparatus so that the user can restart the interrupted work in the moving body in accordance with the predetermined information. The predetermined information is the information which instructs the timing for forming the first working environment in the information processing apparatus possessed by the moving body, if the user inevitably interrupts the work which is being executed, due to any emergent situation. The former can form the first working environment in the information processing apparatus during the period, for example, until the user gets on the moving body in accordance with the predetermined information. Further, the former can form the first working environment in the information processing apparatus, if the user gets on the moving body and starts the information processing apparatus. Accordingly, the user can restart the interrupted work opportunely when the user gets on the moving body.

Note that the following two patterns can be assumed as the pattern in which the former forms the first working environment and the user restarts the interrupted work. In the first pattern, the first working environment information, which is acquired by the acquirer, includes the information to indicate whether or not the working environment for the work interrupted by the user is provided. In this case, for example, the former can form the first working environment in the information processing apparatus possessed by the moving body after the acquirer acquires the first working environment information. In the second pattern, the first working environment information does not include the information to indicate whether or not the working environment for the work interrupted by the user is provided. In this case, for example, the former can form the first working environment in the information processing apparatus possessed by the moving body if the request for continuation is accepted from the user.

Further, the work support system described above may further comprise a retainer configured to retain second working environment information in order that a second working environment, which is formed in the information processing apparatus in relation to the interrupted work, is formed in another information processing apparatus which is correlated with the destination and which can be accessed by the user, if the interrupted work is not completed when the moving body arrives at the destination. The second working environment is a working environment which includes the working content executed by the user with respect to the first working environment in the information processing apparatus possessed by the moving body during the period until the user moves to the destination by the moving body after the user interrupts the work having been being executed.

With the retainer as described above, the user can form the second working environment in the another information processing apparatus which is correlated with the destination and which can be accessed by the user. Thus, the work, which has been interrupted due to the emergent situation, can be continuously executed by the user in the moving body, and the work, which has been executed in the moving body, can be further restarted and continued by the user from the state provided when the user arrives at the destination.

Further, the former may form the first working environment in the information processing apparatus so that the user can make communication with another person in charge or a plurality of other persons in charge via the information processing apparatus, if the interrupted work is a work which is to be executed by the user together with the another person in charge or the plurality of other persons in charge. The phrase “the user can make communication with another person in charge or a plurality of other persons in charge via the information processing apparatus” refers to, for example, such a working environment that the user can participate in a meeting in session at the workplace by means of a television meeting system. In the case of the former as described above, the user can restart and continue the interrupted work in the moving body, even if the interrupted work is a work to be executed together with the another one person in charge or the plurality of other persons in charge, without being limited to a case in which the user is personally or individually in charge of the interrupted work.

Further, the work management apparatus may also store work information in relation to a work to be executed by the user other than the interrupted work; and the work support system may further comprise an adjuster configured to notify a user terminal or user terminals of another person in charge or a plurality of other persons in charge who is/are in charge of a collaborative work, of an adjustment request for adjusting a schedule of the collaborative work, if the collaborative work, which is to be executed by the user together with the another person in charge or the plurality of other persons in charge after the work to be interrupted is interrupted, is stored in the work management apparatus.

In this case, the work, which is the object of the schedule adjustment, is the work other than the interrupted work, and the work is to be executed by the user. The work is the collaborative work of which the user is in charge together with the plurality of persons in charge after the user interrupts the work to be interrupted. The work, which is the object of the schedule adjustment, may be the collaborative work to be executed within a predetermined period after the user interrupts the work to be interrupted. The predetermined period may be, for example, a number of days designated by the user. In the case of the schedule adjuster as described above, the user can efficiently perform the schedule adjustment, if the user inevitably interrupts the work which is being executed, due to any emergent situation.

Further, the work support system described above may further comprise an information presenter configured to present information desired by the user, depending on a reason why the user has interrupted the work to be interrupted. Accordingly, the work support system can present, to the user, useful information corresponding to the reason (hereinafter referred to as “reason of interruption” as well) why the user has interrupted the work which has been being executed, until the user moves to the destination. The information presenter can present, for example, information in relation to a nursery facility and a medical institution to the user who has interrupted the work which has been being executed, due to a disease of a member of the family. Note that the work support system can present various pieces of information to the user, for example, by previously retaining the information to be presented to the user while being correlated with the reason of interruption. Further, the work support system may present the information relevant to the reason of interruption to the user by collecting the information from various information providing sites and sites of public institutions on the internet. The user can reduce the time required to collect the information in relation to the reason of interruption, and the user can secure the time required to continue the interrupted work during the movement to the destination.

Note that the work support system of the present disclosure may be composed of one or a plurality of processing apparatus or processing apparatuses such as a computer or computers or the like. When the work support system is composed of the plurality of processing apparatuses, the respective configurations of the work support system are provided in a dispersed or decentralized manner in the plurality of processing apparatuses, and the respective processing apparatuses cooperate to realize the processing as the work support system. Further, the work support system of the present disclosure may be formed on the vehicle, or the work support system of the present disclosure may be formed outside the vehicle.

In another aspect, the present disclosure can be grasped from a viewpoint of the method. For example, the present disclosure resides in a work support method for supporting work execution by a user by using an information processing apparatus in a moving body which has the information processing apparatus; the work support method comprising a step of acquiring first working environment information to be used by the user to restart an interrupted work from a work management apparatus for storing work information in relation to the interrupted work, if the user interrupts the work that has been being executed; and a step of forming a first working environment for restarting the interrupted work on the basis of the first working environment information in the information processing apparatus possessed by the moving body, if the user moves to a destination by the moving body after the user interrupts the work to be interrupted. Note that the technical concept, which is disclosed in relation to the work support system described above, can be also applied to the information processing method within a range in which any technical inconsistency is not caused.

According to the present disclosure, it is possible to secure the continuity of the work even when the user interrupts the work and leaves the workplace.

### BRIEF DESCRIPTION OF THE DRAWINGS

FIG. 1 illustrates a schematic arrangement of a moving body system to which a work support system according to an embodiment of the present disclosure is applied.

FIG. 2 illustrates a schematic arrangement of a vehicle, a center server, a work management server, and a user terminal shown in FIG. 1.

FIG. 3 exemplifies a data structure of vehicle management information stored in the center server.

FIG. 4 exemplifies a flow of a vehicle allocation process in the moving body system.

FIG. 5 exemplifies traveling routes to be provided when a vehicle travels from a departure place to a destination.

FIG. 6 exemplifies a data structure of work information stored in the work management server.

FIG. 7 exemplifies a data structure of work interruption information stored in the work management server.

FIG. 8 exemplifies a work support process executed by the center server.

FIG. 9 exemplifies a vehicle utilization request screen to request the utilization of a vehicle.

FIG. 10 illustrates a flow chart which exemplifies a schedule adjustment request process according to a second embodiment.

FIG. 11 illustrates a flow chart which exemplifies an information presenting process according to a third embodiment.

FIG. 12 exemplifies a data structure of work interruption information according to the third embodiment.

FIG. 13 exemplifies a vehicle utilization request screen according to the third embodiment.

### DESCRIPTION OF THE EMBODIMENTS

An explanation will be made below on the basis of the drawings about a specified embodiment of the present disclosure. The configuration, which is described in the embodiment of the present disclosure, is not intended to limit the technical scope of the disclosure only thereto, unless specifically noted.

### First Embodiment

### <System Configuration>

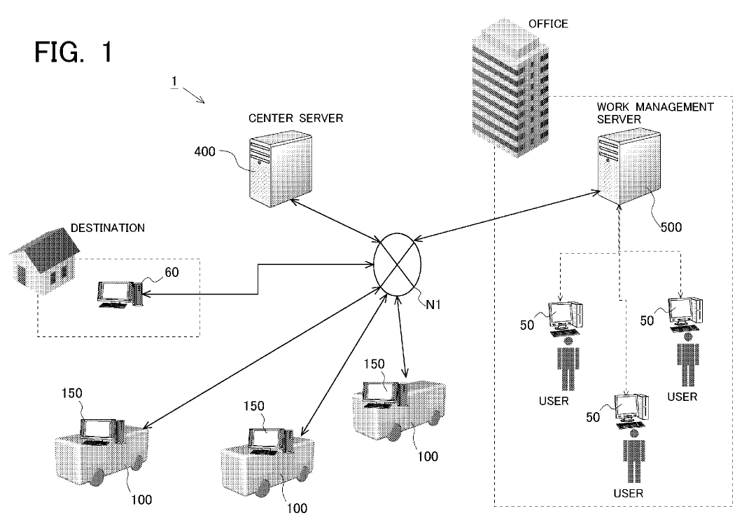

FIG. 1 shows a schematic arrangement of a moving body system to which a work support system according to an embodiment of the present disclosure is applied. At first, the outline of the moving body system will be explained. The moving body system is constructed to include a plurality of autonomous traveling vehicles (hereinafter simply referred to as “vehicles”) 100 which perform the autonomous traveling on the basis of given commands, and a center server 400 which issues the commands. Further, a work management server 500 and user terminals 50 of respective users connected in an office to the work management server 500 are principally shown as the constitutive components relevant to the work support system 1. The vehicle 100 is an automatic driving vehicle for providing a predetermined service, and the center server 400 is an apparatus for managing the plurality of vehicles 100. Note that the plurality of vehicles 100 are included in the moving body system. The work management server 500 is an apparatus for managing, in one office, the works of employees of the company or office staffs (users) belonging to the office. If the user intends to use the vehicle 100 for the work or the like, the access is made to the center server 400 via the work management server 500 from the user terminal 50 of the individual. Note that a user terminal 60, which is installed at user's home (designated as the destination when the user moves by the vehicle 100 as described later on in this embodiment), is also shown in FIG. 1. However, the user terminal 60 is not relevant to the moving body system, but the user terminal 60 is relevant to the work support system 1 of this embodiment. The user terminal 60 is shown in FIG. 1 for the convenience of explanation.

The vehicle 100 is a multipurpose moving body in which the function possessed thereby can be changed for each individual, and the vehicle 100 is a vehicle which autonomously travels on the road. The vehicle 100, which is utilized in the moving body system, has an object to move the user to a predetermined destination in accordance with a request of the user. In this case, the predetermined destination is designated by the user. However, the route, along which the user arrives at the destination, may be designated by the user. In another method, the route may be appropriately determined on the side of the moving body system. Note that an information processing apparatus 150 is required to be carried on the vehicle 100 to which the work support system 1 according to this embodiment is applied as described later on. The other construction of the vehicle 100 is not limited to any special one provided that the information processing apparatus 150 is carried. Further, it is not necessarily indispensable that the vehicle 100 is unmanned. For example, a personnel for security and/or a personnel for providing the service to the user who gets on the vehicle 100 may get on the vehicle 100. It is not necessarily indispensable that the vehicle 100 always performs the autonomous traveling. For example, the vehicle 100 may be a vehicle which is driven by the user or which is assisted for the driving by the user depending on the situation.

In the example shown in FIG. 1, the center server 400, the vehicles 100, and the work management server 500 are connected to one another by a network N1 in the moving body system. Note that the network N1 is, for example, the global scale public communication network such as the internet or the like, for which it is also allowable to adopt any communication network such as WAN (Wide Area Network) and the like. Further, the network N1 may include the telephone communication network for the mobile phone or the like, and the wireless communication network such as WiFi or the like. Note that the user terminals 50 of the respective users are connected to the work management server 500 by means of an intranet constructed in the office. The intranet may also include the telephone communication network for the mobile phone or the like, and the wireless communication network such as WiFi or the like.

The center server 400 is an apparatus which commands the vehicle 100 to operate when a utilization request for the vehicle 100 is given from the user in the moving body system. When the utilization request is accepted from the user, the point (departure place) for the vehicle to go to pickup the user and the destination of the movement of the user are acquired. After that, one vehicle 100 is selected from the vehicles 100 which are traveling in the vicinity of the location of the user, and the operation command “transport the user from the departure place (pickup point) to the destination” is transmitted thereto. Accordingly, the vehicle 100 can be allowed to travel along a predetermined route. Note that the operation command may include the command given to the vehicle 100 in order to provide a predetermined service to the user in response to the request from the user or irrelevant to the intention of the user, in addition to the command to perform the traveling for connecting the departure place and the destination.

Further, the center server 400 also serves as a control apparatus (controller) for supporting the work execution by the user who intends to move to the predetermined destination by utilizing the vehicle 100 in the work support system 1 of this embodiment. In this case, the center server 400 acquires the information (information corresponding to the “work information” described later on) relevant to the work of the user from the work management server 500. After that, a predetermined process is performed so that the user can efficiently execute his/her own work in the vehicle 100 which is moving. The predetermined process is a process which is performed independently from the transmitting process for transmitting the operation command to the vehicle 100. However, the process is performed to support the work of the user while considering that the vehicle 100 moves to the destination in accordance with the autonomous driving.

Further, the work management server 500 is primarily an apparatus which is provided to manage the works of which the individual users belonging to one office are in charge. The work management server 500 has the work management database for managing the work of the user, wherein, for example, the content and the progress of the work of which each of the users is in charge are managed. The user executes his/her own work by utilizing his/her own user terminal 50. Further, the user himself/herself inputs the progress into the work management database in some cases. If the user receives, on the terminal, for example, the decision in relation to the progress of the work from his/her superior during the process of the execution of the work, the progress of the work is automatically inputted into the work management database, for example, automatically at the timing of the decision in other cases. As described above, the work management server 500 is primarily provided to perform the work management for each of the users in one office. However, as described above, when the center server 400 supports the execution of the work by the user, the work management server 500 is cooperated with the center server 400 in order that the necessary information, which is stored in the work management server 500, is provided to the center server 400. The work management server 500 is an example of the “work management apparatus”.

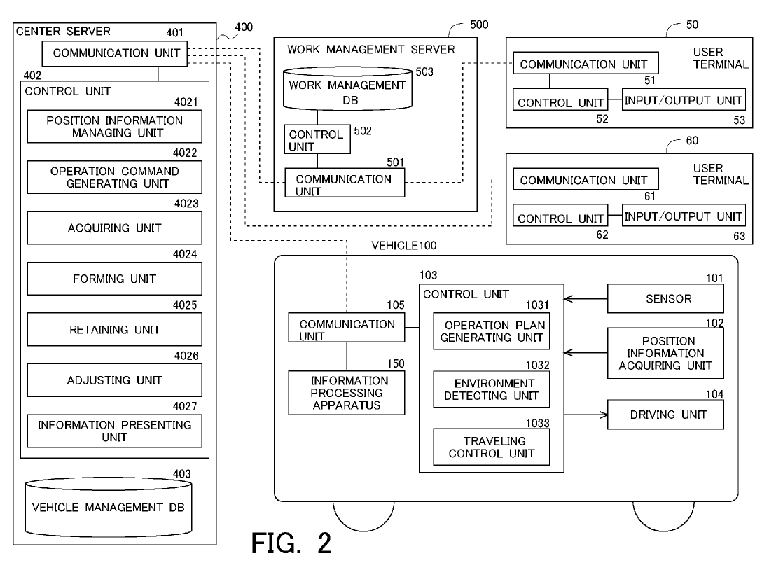

FIG. 2 shows a schematic arrangement of the vehicle, the center server, the work management server, and the user terminal shown in FIG. 1. An explanation will be made on the basis of FIG. 2 about the hardware configuration and the functional configuration of the vehicle 100, the center server 400, the work management server 500, and the user terminals 50, 60.

The vehicle 100 is a vehicle which travels in accordance with the operation command acquired from the center server 400. Specifically, the traveling route is generated on the basis of the operation command acquired via the wireless communication, and the vehicle travels on the road by means of a method adequate for the autonomous traveling while performing the sensing around the vehicle. The vehicle 100 is constructed to include a sensor 101, a position information acquiring unit 102, a control unit 103, a driving unit 104, a communication unit 105, and an information processing apparatus 150. The vehicle 100 is operated by the electric power supplied from an unillustrated battery.

The sensor 101 is the means for performing the sensing around the vehicle 100 in order to acquire the information necessary for the autonomous traveling of the vehicle 100. Typically, the sensor 101 is constructed to include a stereo camera, a laser scanner, LIDAR, and a radar. The information, which is acquired by the sensor 101, is transmitted to the control unit 103. The information is utilized by the control unit 103, for example, in order to recognize the traveling lane and/or the obstacle existing around the vehicle 100. In this embodiment, the sensor 101 includes a visible light camera to perform the monitoring. Further, the position information acquiring unit 102 is the means for acquiring the present position of the vehicle 100. Typically, the position information acquiring unit 102 is constructed to include, for example, a GPS receiver. The information, which is acquired by the position information acquiring unit 102, is also transmitted to the control unit 103. For example, the information is utilized for a predetermined process such as the calculation of the route in order that the vehicle 100 arrives at the destination by utilizing the present position of the vehicle 100.

The control unit 103 is a computer which performs the control of the vehicle 100 on the basis of the information acquired from the sensor 101 and the position information acquiring unit 102. The control unit 103 is constructed, for example, by a microcomputer. Programs, which are stored in the storage means (for example, ROM (Read Only Memory) or the like, not shown), are executed by CPU (Central Processing Unit) (not shown), and thus the functions are realized to perform the various processes described above. As specified examples of the various processes, the control unit 103 has functional modules of an operation plan generating unit 1031, an environment detecting unit 1032, and a traveling control unit 1033.

The operation plan generating unit 1031 acquires the operation command from the center server 400, and the operation plan generating unit 1031 generates the operation plan of the subject vehicle. The information, which relates to the departure place and the destination given to the vehicle 100, is included in the operation command. Therefore, the operation plan generating unit 1031 calculates the route along which the vehicle 100 should advance, and the operation plan generating unit 1031 generates the operation plan, on the basis of the destination given from the center server 400 and the position of the subject vehicle obtained from the position information acquiring unit 102. The operation plan includes the data which relates to the route along which the vehicle 100 travels as calculated as described above and the data which defines the process to be performed by the vehicle 100 on a part or all of the route. The data, which is included in the operation plan, is exemplified, for example, by those described in (1) and (2) as follows.

(1) Data in which Route for Allowing Subject Vehicle to Travel is Represented by Set of Road Links

The route, on which the subject vehicle travels, may be automatically generated, for example, on the basis of the given departure place and the destination by making reference to the stored map data. Note that the calculation of the route for allowing the subject vehicle to travel may rely on any process of an external apparatus (for example, the center server 400) without using any internal apparatus of the vehicle 100. In this case, the center server 400 acquires the subject vehicle position from the vehicle 100, and the center server 400 calculates the route along which the vehicle 100 should advance. Further, the calculated route data may be either included in the operation command described above or transmitted to the vehicle 100 distinctly.

(2) Data which Represents Process to be Performed by Subject Vehicle at any Point on Route

The process, which is to be performed by the subject vehicle, includes, for example, “allow user to get on or get off vehicle” and “temporarily stop”. However, there is no limitation thereto. The operation plan, which is generated by the operation plan generating unit 1031, is transmitted to the traveling control unit 1033 described later on.

The environment detecting unit 1032 detects the environment around the vehicle 100 required for the autonomous traveling, on the basis of the data acquired by the sensor 101. The detection target is, for example, the number and the position(s) of the lane(s), the number and the position(s) of the vehicle(s) existing around the subject vehicle, the number and the position(s) of the obstacle(s) existing around the subject vehicle (for example, pedestrian, bicycle, structure, and building), the structure of the road, and the road sign. However, there is no limitation thereto. The detection target may be anyone provided that the target is required to perform the autonomous traveling. For example, when the sensor 101 is a stereo camera, the object existing around the vehicle 100 is detected by performing the image processing for the image data picked up thereby. Further, the environment detecting unit 1032 not only merely detects the object existing around the vehicle 100, but the detected object may be also subjected to the tracking (detected object is continuously detected successively). For example, it is possible to determine the relative velocity of the object from the difference between the coordinates of the object detected one step before and the present coordinates of the object. The data relevant to the environment around the vehicle 100 (hereinafter referred to as “environment data”), which is detected by the environment detecting unit 1032, is transmitted to the traveling control unit 1033 described later on.

The traveling control unit 1033 generates the control command in order to control the autonomous traveling of the subject vehicle on the basis of the operation plan generated by the operation plan generating unit 1031, the environment data generated by the environment detecting unit 1032, and the position information of the subject vehicle acquired by the position information acquiring unit 102. For example, the traveling control unit 1033 generates the control command in order to allow the subject vehicle to travel so that the subject vehicle travels along a predetermined route and any obstacle does not enter a predetermined safe area around the center of the subject vehicle. The generated control command is transmitted to the driving unit 104 described later on. As for the method for generating the control command for allowing the vehicle to perform the autonomous traveling, it is possible to adopt any known method.

The driving unit 104 is the means for allowing the vehicle 100 to travel on the basis of the control command generated by the traveling control unit 1033. The driving unit 104 is constructed to include, for example, a motor for driving wheels, an inverter, a brake, and a steering mechanism. For example, the motor and the brake are driven in accordance with the control command, and thus the autonomous traveling of the vehicle 100 is realized. Further, the communication unit 105 is the communication means for connecting the vehicle 100 to the network N1. In this embodiment, the communication unit 105 can make communication with other apparatuses (for example, the center server 400) via the network N1 by utilizing the mobile communication service such as 3G (3rd Generation), LTE (Long Term Evolution) or the like.

Further, the vehicle 100 is provided with the information processing apparatus 150. The information processing apparatus 150 is the apparatus which has predetermined functions to such an extent that the user, who gets on the vehicle 100, can execute the work. The information processing apparatus 150 is constructed to include, for example, PC (personal computer) which serves as a main processing apparatus body, a display and a printer which serve as output devices, and a mouse, a keyboard and the like which serve as input devices. Further, the information processing apparatus 150 may be constructed to include a touch panel display which serves as both of the input device and the output device. The information processing apparatus 150 is the apparatus which is provided to contribute to the execution of the work by the user as described above, and the information processing apparatus 150 is constructed so that the apparatus does not participate in the autonomous traveling of the vehicle 100 in principle. Therefore, the information processing apparatus 150 is constructed so that the apparatus does not act on the control unit 103 in principle. However, the information processing apparatus 150 is constructed so that the apparatus can make communication with the center server 400 via the communication unit 105. The information processing apparatus 150 is constructed so that the information, which is provided to support the execution of the work by the user, can be sent/received between the information processing apparatus 150 and the center server 400.

Next, the center server 400 will be explained. The center server 400 is the apparatus which manages the autonomous traveling of the plurality of vehicles 100 and which transmits the operation commands. For example, if the center server 400 receives the request for utilization of the vehicle 100 from the user, then the center server 400 acquires the departure place (position at which the user gets on the vehicle) and the destination, and then the center server 400 transmits the operation command to the vehicle 100 which is traveling in the vicinity of the departure place. Further, the center server 400 also serves as such an apparatus that the support process is performed so that the user, who inevitably interrupts the work which is being executed, for example, due to a disease of a member of the family, can continuously execute the interrupted work in the vehicle 100 during the movement to the destination. In this case, for example, the center server 400 acquires the first working environment information which is used to restart the interrupted work by the user in the vehicle 100 and which is included in the work information relevant to the interrupted work when the user interrupts the work having been being executed, and the center server 400 forms the first working environment in order to restart the interrupted work on the basis of the first working environment information.

Then, the center server 400 is configured as a general computer. Specifically, the center server 400 is the computer which has a processor (not shown) such as CPU (Central Processing Unit), DSP (Digital Signal Processor) and the like, a main storage unit (not shown) such as RAM (Random Access Memory), ROM (Read Only Memory) and the like, and an auxiliary storage unit (not shown) such as EPROM (Erasable Programmable ROM), a hard disk drive (HDD, Hard Disk Drive), a removable media and the like. Note that the removable media is, for example, a disk storage medium such as USB (Universal Serial Bus) memory, CD (Compact Disc), DVD (Digital Versatile Disc) and the like. For example, an operating system (Operating System: OS), various programs, and various tables are stored in the auxiliary storage unit. The programs stored therein are loaded and executed on the working area of the main storage unit, and the respective configuration units and the like are controlled in accordance with the execution of the programs. Thus, it is possible to realize the functions which conform to the predetermined purpose.

The center server 400 has a communication unit 401. The communication unit 401 is connected to another apparatus via the network N1 to perform the communication, for example, with respect to the vehicle 100 and the work management server 500. The communication unit 401 is, for example, a LAN (Local Area Network) interface board or a wireless communication circuit for the wireless communication. The LAN interface board and the wireless communication circuit are connected to the network N1 such as the internet or the like which is the public communication network.

Further, the center server 400 has, in its auxiliary storage unit, a vehicle management DB 403 which stores various pieces of information in relation to the plurality of vehicles 100 that perform the autonomous traveling. The database (DB) is constructed such that the program of the database management system (Database Management System DBMS), which is executed by the processor, manages the data stored in the auxiliary storage unit. The vehicle management DB 403 is, for example, a relational database.

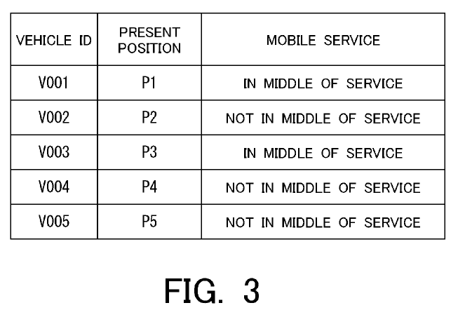

An explanation will now be made on the basis of FIG. 3 about the configuration of the vehicle management information stored in the vehicle management DB 403. FIG. 3 exemplifies the table configuration of the vehicle management information. The vehicle management information table has respective fields of “vehicle ID”, “present position”, and “mobile service”. The identification information, which is provided to specify all of the vehicles managed by the center server 400 in the moving body system, is inputted into the vehicle ID field. The information, which is provided to specify the place at which each of the vehicles 100 is positioned at the present point in time, is inputted into the present position field. Specifically, the information relates to the latitude and the longitude for specifying the present position of the vehicle 100. Every time when the information, which is acquired by the position information acquiring unit 102 in the vehicle 100, is transmitted from the vehicle 100 to the center server 400, the present position field, which corresponds to the vehicle 100 in the vehicle management DB 403, is updated. The information, which indicates whether or not the vehicle 100 is in the middle of the provision of the mobile service for the user by means of the autonomous traveling, is inputted into the mobile service field. For example, if the vehicle 100 is providing the mobile service, “in middle of service” is inputted into the mobile service field. If the vehicle 100 is not providing the mobile service, “not in middle of service” is inputted into the mobile service field. If a request for utilization of the vehicle 100 is given from the user, the center server 400 allocates the vehicle 100 located nearer to the workplace of the user, as selected from the vehicles 100 which are not in the middle of the service.

Further, the vehicle management information may have fields of the processing device (processing unit or processor) specification and the output device (output unit) specification (not shown) relevant to the information processing apparatus 150 provided for the vehicle 100. The processing device specification represents the information which relates to, for example, the type of the application used for the work of the user and the processing ability of the main processing device body required to execute the application (for example, type of OS (Operating System), memory capacity, and CPU performance). Further, the output device specification represents the information which relates to, for example, the size and the number of display(s) as the output device(s) required for the work of the user and the presence or absence of the printer. The center server 400 can prepare the vehicle 100 provided with the device specification for forming the working environment of the interrupted work interrupted by the user due to the emergent situation, by managing the processing device specification and the output device specification.

Further, as shown in FIG. 2, a control unit 402 is formed as the functional unit by executing the program by the processor as described above in the center server 400. As described above, the control unit 402 performs the process which relates to the autonomous traveling of the vehicle 100, and the process which relates to the support for the work execution by the user if the user, who interrupts the work that has been being executed due to the emergent situation, executes the interrupted work continuously in the vehicle 100 that moves to the destination or after the arrival at the destination. In particular, the control unit 402 includes, as functional units, a position information managing unit 4021, an operation command generating unit 4022, an acquiring unit 4023, a forming unit 4024, a retaining unit 4025, an adjusting unit 4026, and an information presenting unit 4027. Among them, the position information managing unit 4021 and the operation command generating unit 4022 are the functional units which relate to the process relevant to the autonomous traveling of the vehicle 100. Further, the acquiring unit 4023, the forming unit 4024, the retaining unit 4025, the adjusting unit 4026, and the information presenting unit 4027 are the functional units which relate to the process relevant to the support for the work execution by the user. The vehicle 100 is an example of the “moving body”.

At first, the position information managing unit 4021 and the operation command generating unit 4022 will be explained. The position information managing unit 4021 collects and manages the position information from the plurality of vehicles 100 which are managed by the center server 400. Specifically, the present position information is received from the plurality of vehicles 100 at the concerning point in time in every predetermined cycle, and the information is stored in the vehicle management DB 403.

If a request for utilization of the vehicle 100 is received from the user, then the operation command generating unit 4022 determines the vehicle 100 which is to be allocated to the user, and the operation command generating unit 4022 generates the operation command corresponding to the utilization request. The utilization request includes the information relevant to the departure place at which the user gets on the vehicle 100 and the destination at which the user gets off the vehicle 100. Further, the utilization request can also include the transit point via which the user goes in the course of the travel from the departure place to the destination. When the transit point is included in the utilization request, if the user intends to stop the vehicle 100 for a predetermined time at the transit point, then this intention may be included in the utilization request. When the utilization request is received as described above, the operation command generating unit 4022 generates the operation command on the assumption that the vehicle 100 goes via the designated transit point and the vehicle 100 stops for the predetermined time at the transit point.

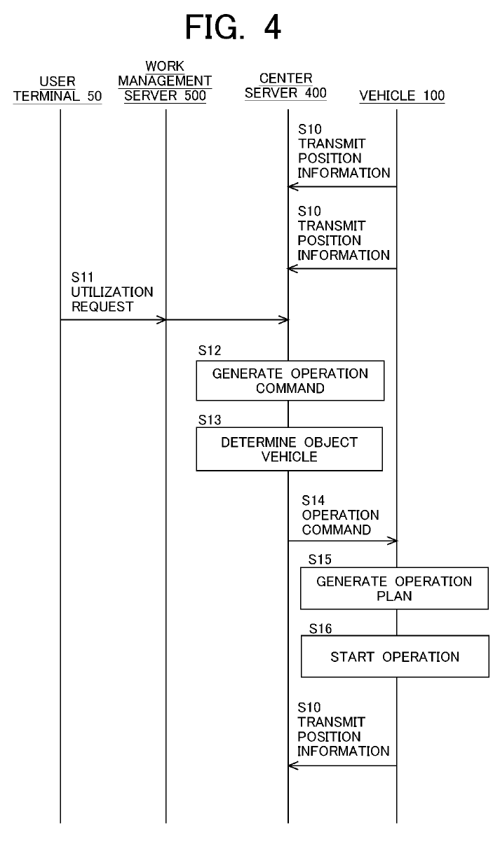

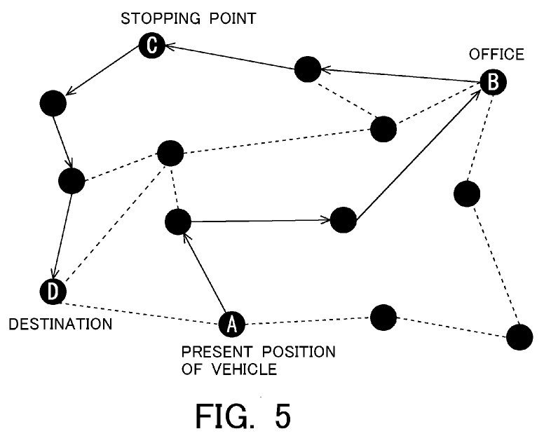

An explanation will now be made on the basis of FIG. 4 about the process flow until the vehicle 100 starts the mobile service for the user by means of the autonomous traveling after the operation command generating unit 4022 generates the operation command on the basis of the utilization request of the user. In this embodiment, an explanation will be made on the basis of an example in which the vehicle 100 operates in a road network shown in FIG. 5.

The vehicle 100 periodically notifies the center server 400 of the position information (S10). In the center server 400, the accepted present position information is inputted into the present position field corresponding to the vehicle 100 in the vehicle management DB 403. The process of S10 is repeatedly executed at constant time intervals.

If the user transmits the utilization request to require the allocation (preparation) of the vehicle 100 with respect to the center server 400 via the work management server 500 from the user terminal 50 described later on (S11), the operation command generating unit 4022 of the center server 400 generates the operation command in response to the utilization request (S12). The operation command designates at least the departure place and the destination. Further, the operation command may designate the traveling route along which the vehicle 100 arrives at the destination from the departure place. Further, the operation command may include the information in relation to the process to be performed on the road and the service to be provided. In this case, it is assumed that the movement of the user from Node B to Node D is requested.

In S13, the operation command generating unit 4022 determines the vehicle 100 which provides the mobile service to the user. For example, the operation command generating unit 4022 makes reference to the present position information of the vehicle 100 stored in the vehicle management DB 403 to determine the vehicle 100 which can provide the mobile service requested for utilization. For example, in the case of the utilization request in which the user desires the immediate utilization, the vehicle, which does not provide the mobile service at that point in time and which is located nearest to the departure place of the user or which can arrive at the departure place of the user earliest, is determined as the vehicle 100 corresponding to the utilization request, on the basis of the vehicle management information stored in the vehicle management DB 403. In this embodiment, it is assumed that the vehicle is determined to be the vehicle 100 which is positioned at Node A shown in FIG. 5. In response thereto, the operation command is transmitted from the center server 400 to the vehicle 100 (S14).

Subsequently, in S15, the operation plan generating unit 1031 of the vehicle 100 generates the operation plan on the basis of the operation command received from the center server 400. In the case of this embodiment, for example, the operation plan is generated so that the vehicle travels along the route indicated by solid lines in FIG. 5, the user gets on the vehicle at Node B, and the user gets off the vehicle at Node D. The generated operation plan is transmitted to the traveling control unit 1033, and the operation is started (S16). Note that the present position information of the vehicle 100 is also periodically transmitted during the operation with respect to the center server 400.

Note that this embodiment exemplifies such a case that the vehicle 100 generates the operation plan on the basis of the utilization request by way of example. However, the operation plan may be generated by the center server 400. In this case, the operation plan, which is generated by the center server 400, is transmitted to the vehicle 100 determined in S13.

Next, an explanation will be made about the acquiring unit 4023, the forming unit 4024, the retaining unit 4025, the adjusting unit 4026, and the information presenting unit 4027 in relation to the work support system 1.

The acquiring unit 4023 acquires the working environment information used by the user to restart the interrupted work, from a work management DB (database) 503 of the work management server 500 described later on for storing the work information relevant to the interrupted work when the user interrupts the work that has been being executed. The working environment information is the information of, for example, the storage location of the file or the data in the working state and the place where a meeting is held in relation to the meeting in session.

The forming unit 4024 forms the working environment of the interrupted work of the user in the information processing apparatus 150 possessed by the vehicle 100 on the basis of the working environment information acquired by the acquiring unit 4023 from the work management DB 503. The forming unit 4024 can form the working environment having been formed upon the interruption, by making the setting so that the user can access the file or the data having been in the working state from the information processing apparatus 150 and/or copying the file or the data having been in the working state into the information processing apparatus 150. Further, if the executing work of the user is the participation in a meeting, the forming unit 4024 can form the working environment having been formed upon the interruption, by means of a television meeting system so that the communication can be performed from the information processing apparatus 150 with respect to the place where the meeting, in which the user participated, is held.

Further, if the information, which is usable to form the working environment of the executing work when the user arrives at the destination, is stored in the work management DB 503, the forming unit 4024 can also form the working environment to be provided when the user arrives at the destination, in another information processing apparatus which is correlated with the destination and which can be accessed by the user.

If the interrupted work is not completed when the vehicle 100 arrives at the destination, the retaining unit 4025 retains the second working environment information in order that the second working environment, which is formed in the information processing apparatus 150 in relation to the interrupted work, is formed in another information processing apparatus which is correlated with the destination and which can be accessed by the user. The retaining unit 4025 may retain the second working environment information, for example, in the work management DB 503. When the user arrives at the destination, the user interrupts again the work having been continued in the vehicle 100. On this account, the acquiring unit 4023 acquires, from the work management DB 503, the second working environment information in the information processing apparatus 150 provided when the user arrives at the destination. Then, if the user desires to restart the interrupted work when the user arrives at the destination, the forming unit 4024 can form the second working environment in another information processing apparatus which is correlated with the destination and which can be accessed by the user, on the basis of the second working environment information.

If any collaborative work, which is to be executed by the user together with another person in charge or a plurality of other persons in charge within a predetermined period after the work to be interrupted is interrupted, is stored in the work management DB 503, the adjusting unit 4026 notifies the user terminal(s) of the another person in charge or the plurality of other persons in charge who is/are in charge of the collaborative work, of an adjustment request for adjusting the schedule of the collaborative work.

The information presenting unit 4027 presents, to the user, the information desired by the user by the aid of the user terminal 50 or the information processing apparatus 150 possessed by the vehicle 100, in accordance with the reason why the user interrupts the executing work. For example, if the user interrupts the executing work due to a disease of a child, the information presenting unit 4027 presents the information of, for example, the opening hours and the homepage address of any sick child nursery facility and the contact address of any children's clinic. The information presenting unit 4027 can present the information corresponding to the reason of interruption, for example, such that the child care information or the nursing information, which is presented by the public institution, is retained while being correlated with the reason of interruption of the work.

Any one of the respective functional constitutive elements or components of the center server 400 or a part of the process thereof may be executed by another computer connected to the network N1. Further, the series of processes executed by the center server 400 can be executed by the hardware, but the processes can be also executed by the software.

Next, the work management server 500 will be explained. The work management server 500 is configured as a general computer. Basically, the work management server 500 manages the progress of the respective works of the plurality of users belonging to the office. Therefore, the user terminal 50 of each of the users can access the work management server 500 via the intranet in the office. Further, the user can access the center server 400 via the work management server 500 from the user terminal 50 to submit the utilization request for the vehicle 100. In this procedure, the work management server 500 performs the relay process between the user terminal 50 and the center server 400.

In particular, the work management server 500 is a computer which has a processor (not shown) such as CPU, DSP and the like, a main storage unit (not shown) such as RAM, ROM and the like, and an auxiliary storage unit (not shown) such as EPROM, a hard disk drive, a removable media and the like, in the same manner as the center server 400. For example, an operating system, various programs, and various tables are stored in the auxiliary storage unit. The programs stored therein are loaded and executed on the working area of the main storage unit, and the respective configuration units and the like are controlled in accordance with the execution of the programs. Thus, it is possible to realize the functions which conform to the predetermined purpose.

Further, the work management server 500 has a communication unit 501. The communication unit 501 is connected to another apparatus to perform the communication between the work management server 500 and the another apparatus (for example, center server 400), in the same manner as the communication unit 401 of the center server 400. The communication unit 501 is, for example, a LAN interface board or a wireless communication circuit for the wireless communication. The LAN interface board and the wireless communication circuit are connected to the network N1 such as the internet or the like which is the public communication network.

Further, the work management server 500 has the work management DB (database) 503 described above. The work management DB 503 stores the work management information relevant to the work to be executed by each of the users in the auxiliary storage unit described above, in which the linking is effected between each of the users and the corresponding work management information. The work management DB 503 is constructed such that the program of the database management system, which is executed by the processor, manages the data stored in the auxiliary storage unit. The work management DB 503 is, for example, a relational database.

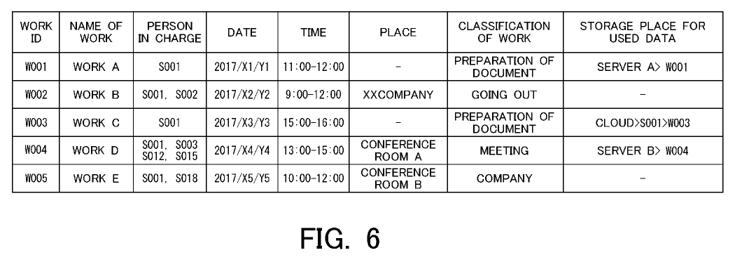

An explanation will now be made on the basis of FIG. 6 about the configuration of the work information stored in the work management DB 503. FIG. 6 exemplifies a data structure of the work information stored in the work management server. The work information table, which stores the work information, is used to manage, for example, the person in charge and the schedule of the work to be executed by the user and the information for forming the working environment. The information for forming the working environment is acquired from the computer with which the user has executed the work, for example, the user terminal 50 or the information processing apparatus 150, and the information is stored in the work information table. One record of the work information table is prepared for every work of which the user is in charge. The record of the work information table may be registered, for example, by inputting the work information of the work of which the user himself/herself is in charge, into the user terminal 50 by the user. The work information table has respective fields of “work ID”, “name of work”, “person in charge”, “date”, “time”, “place”, “classification of work”, and “storage place for used data”.

The work ID field stores the identifier for identifying the work. The work ID is allotted, for example, when the work information, which is inputted from the user terminal 50 by the user, is registered in the work information table. The name of work field stores the name of work which indicates the content of the work identified by the work ID. The name of work can be, for example, a name of work which is set when the user registers the work information.

The person in charge field stores the user ID of the user who is in charge of the work. The user ID is the identification information for specifying the user, which can be, for example, the number such as an employee number or the like which is inherently allotted to the user beforehand. A plurality of users may be in charge of the work. The date field stores the date on which the work is scheduled to be executed. The time field stores the time (time zone) on which the work is scheduled to be executed.

The place field stores the place at which the work is scheduled to be executed. The classification of work field stores the classification of the work. The classification of work is, for example, “preparation of document”, “going out”, “meeting”, and “company”. If the user interrupts the work which is being executed, the working environment, which corresponds to the classification of the interrupted work, is formed in the information processing apparatus 150 possessed by the vehicle 100. For example, if the classification of work is “preparation of document”, the working environment is formed so that the data of the document which is being prepared by the user can be edited in the information processing apparatus 150. Further, if the classification of work is “meeting” or “company”, the working environment, which can make communication with, for example, the conference room indicated in the place field, is formed in the information processing apparatus 150. If the classification of work is “going out”, the working environment, which can make communication with the conference room, the guest room or the like located at the going out destination, may be formed in the information processing apparatus 150, if the equipment, which makes it possible to perform the communication with the information processing apparatus 150, is equipped at the going out destination.

The storage place for used data field stores the storage place for the data having been used in the work interrupted by the user. The storage place for used data is indicated by the name of the folder in which the used data of the work interrupted by the user is stored, for example, “Server A>W0001”. When the working environment for restarting the interrupted work of the user is formed in the information processing apparatus 150, the user can restart the interrupted work, for example, by copying the data stored in the folder indicated by the storage place for used data, to the information processing apparatus 150. Further, for example, it is also allowable to adopt such a configuration that the user can restart the interrupted work by making it possible to access the folder indicated by the storage place for used data by the aid of the information processing apparatus 150.

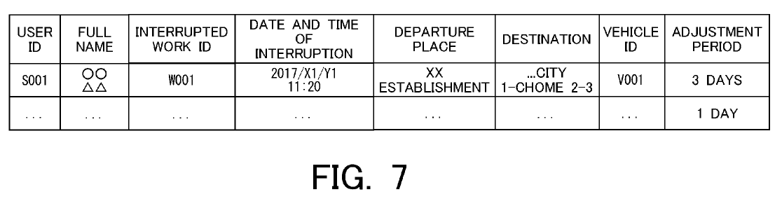

Next, an explanation will be made on the basis of FIG. 7 about the configuration of the work interruption information stored in the work management DB 503. FIG. 7 exemplifies a data structure of the work interruption information. The work interruption information table, which stores the work interruption information, is used in order that the operation command generating unit 4022 generates the operation command for the vehicle 100, the adjusting unit 4026 notifies the user terminal of the request for adjusting the schedule, and the information presenting unit 4027 presents the information, if the user interrupts the work which is being executed. The record of the work interruption information table is prepared when the user instructs the interruption of the work which is being executed. If the user requests the utilization of the vehicle 100 in order to move to the destination, the information concerning, for example, the departure place and the destination used to prepare the vehicle 100 is stored in the corresponding record. The work interruption information table has respective fields of “user ID”, “full name”, “interrupted work ID”, “data and time of interruption”, “departure place”, “destination”, “vehicle ID”, and “adjustment period”.

The user ID field stores the identification information in order to specify the user. The user ID can be, for example, the number such as an employee number or the like which is inherently allotted to the user beforehand. The full name field stores the full name of the user.

The interrupted work ID field stores the work ID of the work interrupted by the user due to the emergent situation. The interrupted work ID field is allowed to correspond to the work ID field of the work information table shown in FIG. 6. The work information of, for example, the person in charge in relation to the interrupted work can be acquired from the record of the work information table having the same work ID as that of the interrupted work ID.

The data and time of interruption field stores the date and time at which the user interrupted the work having been being executed. The data and time of interruption is not limited to the data on which the user utilizes the vehicle 100. The data and time of interruption may be a day on which user requests the utilization of the vehicle 100. The data and time of interruption is used to specify the work which is the object of the schedule adjustment. For example, the work, which is the object of the schedule adjustment, can be such a work that the values of the date field and the time field of the work information table shown in FIG. 6 are later than the data and time of interruption. Alternatively, the work, which is the object of the schedule adjustment, may be the work which is included in the adjustment period described later on after the date and time of interruption.

The departure place field stores the position at which the user, who has requested the utilization of the vehicle 100 on account of the interruption of the work, gets on the prepared vehicle 100. The departure place is, for example, the workplace at which the user executes the work, which may be allowed to correspond to the actual address of the workplace.

The destination field stores the movement destination of the user who interrupted the work having been being executed. The destination may be, for example, the home address of the user or the address of the nursery facility at which the user leaves his/her child in their care. The vehicle ID field stores the identification information of the vehicle 100 prepared to continue the interrupted work when the user interrupts the work having been being executed. The working environment for the work interrupted by the user is formed in the prepared vehicle 100.

The adjustment period field stores the period which is the object for carrying out the schedule adjustment on or after the date and time of interruption. The adjustment period is used to specify the work which is the object for the schedule adjustment. For example, the work, which is the object for the schedule adjustment, can be the work in which the values of the date field and the time field of the work information table shown in FIG. 6 are included in the adjustment period after the date and time of interruption. If the work as the object for the schedule adjustment is the collaborative work of which a plurality of users are in charge, the adjusting unit 4026 notifies the persons in charge other than the user who interrupted the work, of the adjustment request for adjusting the schedule. The information, which is stored in the respective fields of the work interruption information table, is inputted, for example, when the user submits the utilization request for utilizing the vehicle 100 by the aid of the user terminal 50, and the information is transmitted to the work management server 500.

Then, the control unit 502 as the functional unit is formed by executing the program by the processor described above in the work management server 500. The control unit 502 performs the management control including, for example, the registration and the updating of the information (work information) relevant to the work of the user in the work management DB 503. The work information, which is registered or updated in the work management DB 503, is inputted, for example, with the computer for allowing the user to execute the work, including, for example, the user terminal 50 or the information processing apparatus 150 installed in the vehicle 100, and the information is transmitted to the work management server 500. The work management server 500 receives the work information transmitted, for example, from the user terminal by the aid of the communication unit 501.

If any new work information is received, the control unit 502 stores (registers) the information in the work management DB 503 while being correlated with the identification information of the user. Further, the control unit 502 updates the information relevant to the corresponding work on the basis of the content of the change of the received work information, in relation to the work having been already registered in the work management DB 503. Further, the control unit 502 performs the relay of the communication between the user terminal 50 and the center server 400 via the communication unit 501, in accordance with the process of each of the functional constitutive elements of the center server 400.

Any one of the respective functional constitutive elements of the work management server 500 or a part of the process performed thereby may be executed by another computer connected to the network N1. Further, the series of processes executed by the work management server 500 can be also executed by the hardware. However, the processes can be also executed by the software.

Next, the user terminal 50 of the user will be explained. In this embodiment, the user terminal 50 is a device or apparatus which is principally utilized by the user to execute his/her own work in the office. However, no problem arises even when the user utilizes the user terminal 50 for any purpose other than the above. The user terminal 50 is a personal computer (Personal Computer, PC) which is connected to the work management server 500 via the intranet in the office. However, the user terminal 50 may be a small-sized computer such as a smartphone, a mobile phone, a tablet terminal, a personal information terminal, or a wearable computer (for example, a smartwatch) which is usable for the work of the user. The user can also make connection from the user terminal 50 via the work management server 500 to the network N1. The user terminal 50 of the user is constructed to include a communication unit 51, a control unit 52, and an input/output unit 53.

The communication unit 51 is the communication means which is provided to make connection with respect to the work management server 500 via the intranet. The control unit 52 is a computer which administers the control of the user terminal 50. The control unit 52 is constructed, for example, by a microcomputer. Functions to perform various processes are realized by executing programs stored in the storage means (ROM or the like) by CPU (any one of them is not shown). Further, the control unit 52 performs the interaction with the user via the input/output unit 53. The input/output unit 53 is the means which accepts the input operation performed by the user and which presents the information with respect to the user. Specifically, the input/output unit 53 is composed of a touch panel and control means thereof, and/or a liquid crystal display and control means thereof. The touch panel and the liquid crystal display are constructed by one touch panel display in this embodiment. Note that the input operation performed by the user is not limited to those performed by the aid of the touch panel display. For example, the input operation may be performed with a hardware switch or the like.

For example, the control unit 52 executes a predetermined application so that the information, which relates to the work of the user himself/herself, is inputted/outputted into/from the work management DB 503 via the input/output unit 53 with respect to the work management server 500. Further, if the user intends to utilize the vehicle 100, the control unit 52 delivers the utilization request of the user via the input/output unit 53 to the center server 400 so that the operation command generating unit 4022 of the center server 400 is allowed to execute the generating process for generating the operation command on the basis of the utilization request.

Next, the user terminal 60 of the user will be explained. In this embodiment, the user terminal 60 is a device or apparatus which is installed in the destination as the destination of movement of the user from the office and which can be accessed by the user. For example, the user terminal 60 is an own information processing apparatus which is provided in the home of the user. The user terminal 60 may be a personal computer, a smartphone, a mobile phone, a tablet terminal, a personal information terminal, or a wearable computer (for example, a smartwatch). The user can also make connection from the user terminal 60 to the network N1.

The user terminal 60 is constructed to include a communication unit 61, a control unit 62, and an input/output unit 63. The communication unit 61 is the communication means which is provided to make connection with respect to the network N1. Further, the input/output unit 63 is constructed in the same manner as the input/output unit 53 described above. Then, the control unit 62 performs the interaction with the user via the input/output unit 63. For example, when the user inputs predetermined information via the input/output unit 63, the control unit 62 executes a predetermined process on the basis of the inputted information. The predetermined process also includes a process for continuously executing the work to be executed which has been executed by the user in the vehicle 100 but which is unsuccessfully completed during the movement as described later on.

### <Flow of Process>

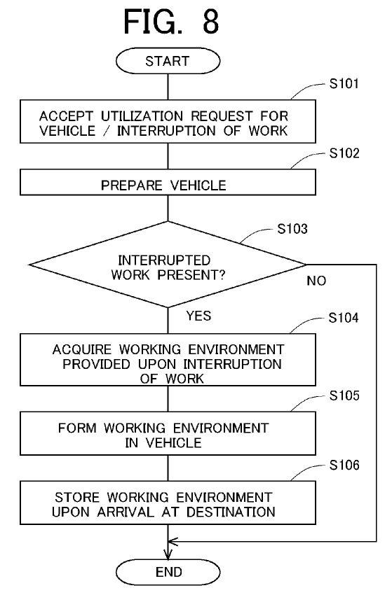

FIG. 8 shows a flow chart which exemplifies the work support process executed by the center server 400. The flow of the process is started, for example, taking the opportunity of the utilization request for the vehicle 100 accepted by the center server 400 from the user terminal 50 via the work management server 500.

At first, in S101, the operation command generating unit 4022 accepts the utilization request for the vehicle 100. Further, the acquiring unit 4023 accepts the interruption of the work having been being executed by the user. The user can request the utilization of the vehicle 100 by inputting, into the user terminal 50, the information concerning the utilization request for the vehicle 100 and the interruption of the work having been being executed, and the user can make instruction so that the interrupted work can be continued in the vehicle 100.

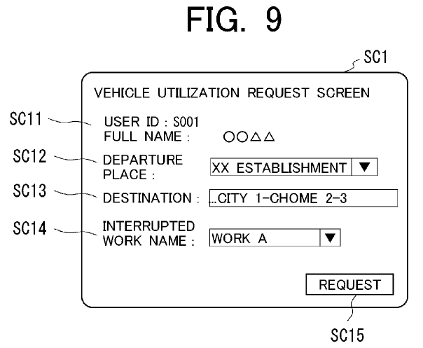

An explanation will now be made on the basis of FIG. 9 about a screen which is provided for the user to request the center server 400 to allow the utilization of the vehicle from the input/output unit 53 of the user terminal 50 via the work management server 500. FIG. 9 exemplifies a vehicle utilization request screen to request the utilization of the vehicle. The vehicle utilization request screen SC1 is a screen which is provided to the user terminal 50 by the work support system 1. The user information SC11 (ID, full name), the departure place SC12, the destination SC13, the interrupted work name SC14, and the request button SC15 affixed with a label of “request” are shown on the vehicle utilization request screen SC1.

The user information SC11 (user ID, full name) is the column (section) provided to indicate the information about the user. The user ID and the full name of the user information are the information previously registered as the user who utilizes the work support system 1 in the work management DB 503 of the work management server 500. The departure place SC12 is the column provided to input the place at which the user gets on the vehicle 100. As shown in FIG. 9, the departure place SC12 may be inputted by being selected from the name of the establishment of the previously registered workplace or the address of the establishment. Further, as for the departure place SC12, the address may be directly inputted. The destination SC13 is the column provided to input the destination to which the user moves. As for the destination SC13, for example, the home address of the user or the address of the nursery facility at which the user leaves his/her child in their care is inputted.

The interrupted work name SC14 is the column provided to select the work name of the work to be interrupted by the user due to the emergent situation. If the user has any work which is being executed and which is desired to be continuously executed in the vehicle 100, the user selects the work desired to be continued, in the column of the interrupted work name SC14. The user can instruct the interruption of the work by selecting the interrupted work in the column of the interrupted work name SC14. Note that the work name selected herein is the work name which is stored in the work information table shown in FIG. 6 while being correlated with the work ID when the user previously registers the work information.

The request button SC15 is an operation button which is provided to transmit the information selected or inputted on the vehicle utilization request screen SC1 to the work management server 500. If the request button SC15 is depressed, then the control unit 502 of the work management server 500 receives the information inputted on the vehicle utilization request screen SC1 from the user terminal 50, and the received information is stored in the work information table shown in FIG. 6 and the work interruption information table shown in FIG. 7.

In S102 shown in FIG. 8, the operation command generating unit 4022 allocates the vehicle 100. The operation command generating unit 4022 makes reference to the vehicle management information table of the vehicle management DB 403 to allocate the vehicle included in the vehicles 100 in which the mobile service field is “not in middle of service”, the vehicle having, for example, the present position nearer to the departure place of the user. The operation command generating unit 4022 can prepare the vehicle 100 in accordance with the vehicle allocation process exemplified in FIG. 4, and the operation command generating unit 4022 can operate the vehicle until arrival at the departure place of the user.

In S103, the acquiring unit 4023 judges whether the interrupted work is present or absent. The user can instruct the interruption of the work, for example, by selecting the work to be interrupted in the column of the interrupted work name SC14 on the vehicle utilization request screen SC1 and requesting the utilization of the vehicle. It is also allowable that the user can instruct the interruption of the work from the user terminal 50 distinctly from the utilization request for the vehicle. The acquiring unit 4023 can judge the presence or absence of the interrupted work, for example, depending on whether or not the information of the interrupted work is stored in the work interruption information table shown in FIG. 7. If the interrupted work is present (S103: Yes), the process proceeds to S104. If the interrupted work is absent (S103: No), the process shown in FIG. 8 is terminated.

In S104, the acquiring unit 4023 acquires the information for forming the working environment of the interrupted work provided when the user interrupted the executing work, from the work information table and the work interruption information table of the work management DB 503. For example, if the user having the user ID of S001 (hereinafter referred to as “user S001”) interrupts the work having the work ID of W001 (hereinafter referred to as “work W001”) as shown in FIG. 7, the acquiring unit 4023 acquires the information of the used data storage place of the work information table, as the information for forming the working environment of the interrupted work.

In S105, the forming unit 4024 forms the working environment provided when the user interrupted the executing work, in the information processing apparatus 150 possessed by the vehicle 100 on the basis of the information for forming the working environment acquired in S104. An explanation will be made about a case in which the user S001 interrupts the work W001, for example, as shown in FIG. 7. In the work information table shown in FIG. 6, as for the work W001, the classification of work is “preparation of document”, and the W001 folder of the server A is designated as the storage place for the used data. In this case, the forming unit 4024 copies the file stored in the W001 folder of the server A to the place capable of being accessed by the user in the information processing apparatus 150. Further, the forming unit 4024 may set the network environment of the information processing apparatus 150 so that the user can access the W001 folder of the server A by the aid of the information processing apparatus 150.

In S106, the acquiring unit 4023 transmits, to the work management server 500, the information for forming the working environment provided when the user arrives at the destination. The information is stored in the work information table of the work management DB 503, and the process shown in FIG. 8 is terminated.

Note that the forming unit 4024 can acquire the information for forming the working environment provided when the user arrives at the destination, the information being stored in the work information table of the work management DB 503 in S106. For example, the working environment, which is provided when the user arrives at the destination (home), can be formed in the user terminal 60 provided at the home of the user.

### <Function and Effect of First Embodiment>

The forming unit 4024 of the work support system 1 acquires, from the work management DB 503, the information for forming the working environment provided when the user interrupts the executing work which has been being executed by the user. The working environment is formed in the information processing apparatus 150 possessed by the vehicle 100, in the vehicle 100 by which the user moves to the destination. Accordingly, the user can restart and continue the interrupted executing working in the vehicle 100 by which the user moves to the destination. It is possible to secure the continuity of the work.

The forming unit 4024 of the work support system 1 allows the user to form the first working environment in the information processing apparatus 150 in the vehicle 100 in accordance with the predetermined information which makes instruction to restart the interrupted work in the vehicle 100 during the period until the user moves to the destination by the vehicle 100. Specifically, the forming unit 4024 forms, in some cases, the first working environment in the information processing apparatus 150 in accordance with the predetermined information until the user gets on the moving body. The forming unit 4024 forms, in other cases, the first working environment in the information processing apparatus when the user gets on the moving body and the user starts the information processing apparatus 150. Accordingly, the user can opportunely restart the interrupted work when the user gets on the vehicle 100.

The retaining unit 4025 of the work support system 1 retains the second working environment information which is provided in order that the second working environment, which is formed in the information processing apparatus 150 in relation to the interrupted work, is formed in another information processing apparatus which is correlated with the destination and which can be accessed by the user, if the interrupted work is not completed when the vehicle 100 arrives at the destination. Accordingly, the forming unit 4024 of the work support system 1 can form the second working environment in the another information processing apparatus which is correlated with the destination and which can be accessed by the user. That is, the user can restart the interrupted work from the state provided when the user arrives at the destination. Therefore, the user can efficiently continue the work by utilizing the traveling time until arrival at the destination.

The forming unit 4024 of the work support system 1 may form the first working environment in the information processing apparatus 150 so that the user can make communication with another person in charge or a plurality of other persons in charge via the information processing apparatus 150. For example, the forming unit 4024 can allow a plurality of user terminals 50 of other users and the information processing apparatus 150 to be in a state in which they can make communication as shown in FIG. 1. Further, the forming unit 4024 may allow the information processing apparatus 150 to be capable of being connected, for example, with a television meeting system installed in a conference room in an office. Accordingly, even if the interrupted work is a work which is to be executed by the user together with another person in charge or a plurality of other persons in charge, it is possible to continue the work.

### Second Embodiment

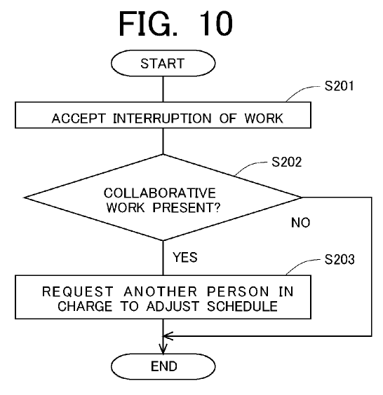

An explanation will be made about the work support control of this embodiment on the basis of FIG. 10. In the first embodiment, if the user interrupts the work which is being executed, the work support system 1 forms the working environment of the interrupted work in the information processing apparatus 150 possessed by the vehicle 100 which is usable for the user to move to the destination. Therefore, the user can continuously executes the interrupted work in the vehicle 100. On the other hand, if the user interrupts the work which is being executed, any other work, of which the user is in charge, may be also affected in some cases. In view of the above, in the second embodiment, the work support system 1 further executes a process for requesting another person in charge other than the user to perform the schedule adjustment in relation to the work to be executed by the user in addition to the work which is interrupted by the user. In the second embodiment, the schedule adjustment request process is executed in addition to the work support control according to the first embodiment shown in FIG. 8. FIG. 10 shows a flow chart which exemplifies the schedule adjustment request process according to the second embodiment. The flow of the process is started, for example, taking the opportunity of the acceptance of such a notification that the user interrupts the work which is being executed, the notification being accepted by the center server 400 from the user terminal 50 via the work management server 500.

At first, in S201, the adjusting unit 4026 accepts the notification that the work, which has been executed by the user, is interrupted. The process of S201 is the same as or equivalent to the process for accepting the interruption of the work in S101 shown in FIG. 8.

In S202, the adjusting unit 4026 judges the presence or absence of the collaborative work which is other than the work interrupted by the user, which is included in the works to be executed by the user, and which is to be executed together with another person in charge or a plurality of other persons in charge after the user interrupts the work. The collaborative work is the work in which a plurality of persons in charge including the user are stored in the value of the person in charge field in the work information table of the work management DB 503. The adjusting unit 4026 can judge the presence or absence of the collaborative work depending on whether or not the record of the collaborative work exists in the work information table. If the collaborative work is present (S202: Yes), the process proceeds to S203. If the collaborative work is absent (S202: No), the process shown in FIG. 10 is terminated.

In S203, the adjusting unit 4026 notifies the user terminal 50 of the person in charge other than the user of the request for the schedule adjustment of the collaborative work in relation to the collaborative work. A specified example will be explained by using the exemplary work information table shown in FIG. 6. It is assumed that the user, who interrupted the work having been being executed due to any emergent situation, is the user having the user ID of S001 (hereinafter referred to as “user S001”). It is assumed that the user S001 interrupted the work W001 due to the emergent situation during the execution of the work W001. In this case, the collaborative works are the work W002, the work W004, and the work W005. In relation to the respective collaborative works, the adjusting unit 4026 notifies the user terminals 50 of the persons in charge other than the user S001 of the requests to adjust the schedules of the respective works. For example, in the case of the work W004, the adjusting unit 4026 notifies the user terminals 50 of the user S003, the user S012, and the user S015 other than the user S001 of the requests to adjust the schedules of the work W004. Note that the user ID's of the respective users are allowed to correspond, in the work management DB 503, for example, to the identification information and the mail addresses of the user terminals 50 corresponding to the respective users. The adjusting unit 4026 can notify the persons in charge of the requests for the schedule adjustment of the collaborative work by using, for example, the identification information of the user terminals 50 and the mail addresses. The adjusting unit 4026 can notify the persons in charge of the requests to adjust the schedules, for example, by transmitting the messages of, for example, the electronic mail, SMS (Short Message Service), or MMS (Multimedia Messaging Service) for requesting the schedule adjustment with respect to the user terminals 50 of the persons in charge other than the user S001.

Further, the notification of the request for the schedule adjustment may be made for only the work which is to be carried out within a predetermined period after the day on which the user S001 interrupted the work W001. The predetermined period can be, for example, the value stored in the adjustment period field of the work interruption information table shown in FIG. 7. It is possible to suppress any unnecessary notification by providing the notification of the request for the schedule adjustment in relation to only the work having the schedule set during the adjustment period after the date and time of interruption on which the user interrupted the work having been being executed.

In the second embodiment, the work support system 1 notifies the user terminal 50 or the user terminals 50 of the another person in charge or the plurality of other persons in charge other then the user, of the adjustment request for adjusting the schedules of concerning another work in relation to the collaborative work to be executed by the user together with the another person in charge or the plurality of other persons in charge after the interruption of the work to be interrupted. Accordingly, if the user inevitably interrupts the work which is being executed due to the emergent situation, the adjusting unit 4026 of the work support system 1 can efficiently perform the schedule adjustment.

### Third Embodiment

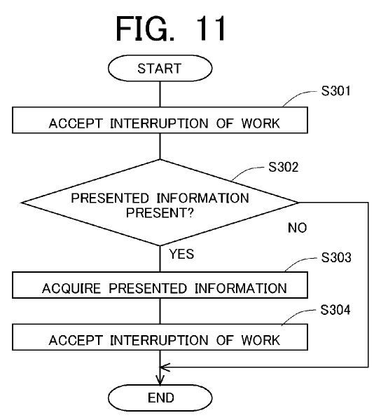

An explanation will be made about the work support control of this embodiment on the basis of FIG. 11. In the first embodiment, if the user interrupts the work having been being executed, the work support system 1 forms the working environment of the interrupted work in the information processing apparatus 150 possessed by the vehicle 100 which is usable for the user to move to the destination. Therefore, the user can continuously execute the interrupted work in the vehicle 100. In the third embodiment, the work support system 1 further presents the information which is desired to be collected during the period until the user moves to the destination. In the third embodiment, an information presenting process is executed in addition to the work support control concerning the first embodiment shown in FIG. 8. FIG. 11 shows a flow chart which exemplifies the information presenting process according to the third embodiment. The flow of the process is started, for example, taking the opportunity of the acceptance of such a notification that the user interrupts the work having been being executed, the notification being accepted by the center server 400 from the user terminal 50 via the work management server 500.

At first, in S301, the information presenting unit 4027 accepts the notification that the user interrupts the work having been being executed. The process of S301 is the same as or equivalent to the process for accepting the interruption of the work in S101 shown in FIG. 8.

In S302, the information presenting unit 4027 judges the presence or absence of the information to be presented to the user. The information, which is to be presented to the user, includes, for example, the information which relates to the reason of the interruption of the work having been being executed, or the information which is desired by the user to be collected. The reason, why the work is interrupted, can be inputted with the user terminal 50 when the user instructs the interruption of the work.

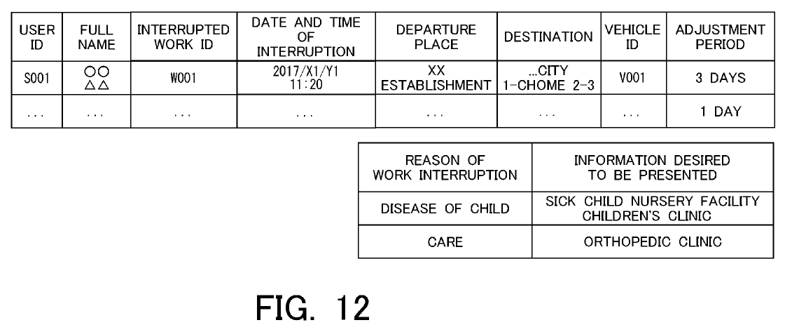

An explanation will now be made on the basis of FIG. 12 about the configuration of the work interruption information including the reason of interruption of the work inputted by the user. FIG. 12 exemplifies a data structure of the work interruption information according to the third embodiment. Any explanation will be omitted about the items common to those shown in the work interruption information table for storing the work interruption information concerning the first embodiment (hereinafter referred to as “work interruption information table shown in FIG. 7”) in relation to the work interruption information table for storing the work interruption information concerning the third embodiment (hereinafter referred to as “work interruption information table shown in FIG. 12”), and an explanation will be made about different items. The work interruption information table shown in FIG. 12 has respective fields of the reason of work interruption and the information desired to be presented, in addition to the respective fields possessed by the work interruption information table shown in FIG. 7.

The reason of work interruption field stores the reason of interruption which is the cause for the user to require the interruption of the work. The information desired to be presented field stores the content of the information which is to be presented as hoped by the user who has interrupted the work in the vehicle 100 during the period in which the user goes toward the destination. As for the information desired to be presented, it is also appropriate to select the information desired to be presented, for example, when the user requires the interruption of the work by the aid of the user terminal 50. The information presenting unit 4027 can present the information of, for example, the neighboring medical institution or the nursery facility desired by the user, on the basis of the information desired to be presented and the position information of the vehicle 100. The information, which is presented to the user, may be the information which is previously registered in the work management DB 503 while being correlated with the reason of work interruption. Further, the information presenting unit 4027 may present the information relevant to the reason of interruption of the work to the user by collecting the information from various information providing sites and sites of public institutions on the internet.

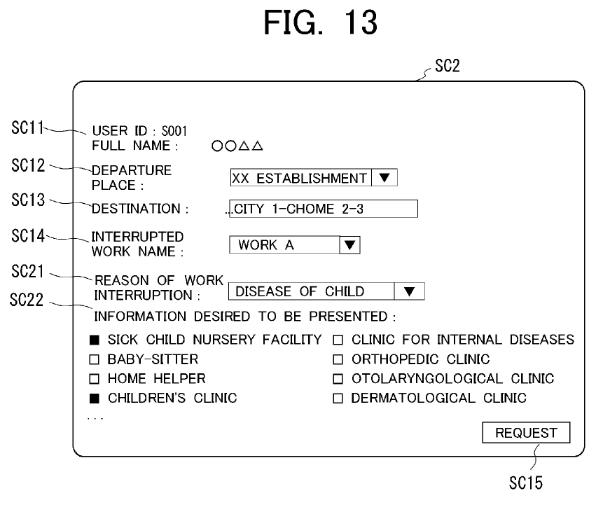

Next, an explanation will be made on the basis of FIG. 13 about the screen on which the information stored in the work interruption information table shown in FIG. 12 is inputted to request the utilization of the vehicle and the presentation of the information. FIG. 13 exemplifies a vehicle utilization request screen according to the third embodiment. The vehicle utilization request screen SC2 shown in FIG. 13 is the screen which is provided to the user terminal 50 by the work support system 1.

The user information SC11 (ID, full name), the departure place SC12, the destination SC13, the interrupted work name SC14, the reason of work interruption SC21, the information desired to be presented SC22, and the request button SC15 affixed with a label of “request” are shown on the vehicle utilization request screen SC2. The user information SC11 (ID, full name), the departure place SC12, the destination SC13, the interrupted work name SC14, and the request button SC15 are the same as the items indicated by the same reference numerals in FIG. 9, and hence any explanation thereof will be omitted.

The reason of work interruption SC21 is the column (section) provided to select the reason of interruption which is the cause for the user to interrupt the executing work which is being executed. The reason of interruption of the work is previously stored, for example, in the database (not shown) of the center server 400 while being correlated with the information to be presented corresponding to the content of the reason of interruption. The information desired to be presented SC22 is the column provided to select the classification of the information intended to be collected by the user during the movement to the destination by the vehicle 100. As exemplified in FIG. 13, it is also allowable that the information desired by the user to be presented can be selected from a plurality of selection candidates depending on the reason of interruption. For example, the information, which is desired to be presented by the user, can be selected from options of, for example, the sick child nursery facility, the baby-sitter, the home helper, the children's clinic, the clinic for internal diseases, the orthopedic clinic, the otolaryngological clinic, and the dermatological clinic. The options, which can be selected in this case, may be changed depending on the reason of work interruption.

In the case of the example of the work interruption information table shown in FIG. 12, the reason, why the user S001 interrupted the work W001, is the disease of child. In this case, the information presenting unit 4027 can present, to the user, options of, for example, the sick child nursery facility, the baby-sitter, the home helper, and the children's clinic on the vehicle utilization request screen SC2. In the case of the work interruption information table shown in FIG. 12, such an example is shown that the user has selected the sick child nursery facility and the children's clinic from the options presented by the information presenting unit 4027. The information presenting unit 4027 presents the information relevant to the sick child nursery facility and the children's clinic in accordance with the selection of the user.

In S303 shown in FIG. 11, the information presenting unit 4027 acquires the presentation information to be presented to the user who is moving by the vehicle 100. The information presenting unit 4027 acquires, for example, the presentation information which is correlated with the reason of interruption selected in the reason of work interruption SC21 on the vehicle utilization request screen SC2. The presentation information includes the information of, for example, the date, the utilization time, the contact address, and the homepage address of the medical institution or various facilities.

Further, the information presenting unit 4027 may acquire the information selected from the options shown in the information desired to be presented SC22 on the vehicle utilization request screen SC2, the information being included in the presentation information correlated with the reason of interruption. The information presenting unit 4027 may present the acquired information to the user. Further, the information presenting unit 4027 may acquire the information to be presented to the user by narrowing or limiting the information to the information concerning the facilities existing in a range of predetermined distance from the address inputted in the destination SC13.

In S304, the information presenting unit 4027 presents the presentation information acquired in S303 to the user who is moving by the vehicle 100. The information presenting unit 4027 presents the presentation information, for example, to the information processing apparatus 150 possessed by the vehicle 100 or the user terminal 50.

In the third embodiment, the work support system 1 presents the information desired by the user, depending on the reason why the user interrupted the work having been being executed. Accordingly, the work support system 1 can present the useful information corresponding to the reason of interruption to the user until the user moves to the destination. Further, the user can reduce the time required to collect the information relevant to the reason of interruption, and the user can secure the time required to continue the interrupted work during the movement to the destination.

### <Recording Medium>

The program, which allows the computer or other machine or apparatus (hereinafter referred to as “computer or the like”) to realize the work support control described above, can be recorded on a recording medium which is readable by the computer or the like. The computer functions as the center server 400 described above by reading and executing the program of the recording medium by the computer or the like.

In this context, the recording medium, which is readable by the computer or the like, refers to any non-transitory recording medium on which the information including, for example, the data and the program can be accumulated by means of the electric, magnetic, optical, mechanical, or chemical action and the information can be read by means of the computer or the like. Among the recording media as described above, those removable from the computer or the like are, for example, flexible disk, magneto-optical disk, CD-ROM, CD-R/W, DVD, blue-ray disk, DAT, 8 mm tape, and memory card such as flash memory or the like. Further, the recording medium fixed to the computer or the like includes, for example, hard disk and ROM. Further, SSD (Solid State Drive) can be utilized either as the recording medium which is removable from the computer or the like or as the recording medium which is fixed to the computer or the like.

What is claimed is:

1. A work support system for supporting work execution by a user by using an information processing apparatus in a moving body which has the information processing apparatus, the work support system comprising:
an acquirer configured to acquire first working environment information to be used by the user to restart an interrupted work from a work management apparatus for storing work information in relation to the interrupted work, if the user interrupts the work that has been being executed; and
a former configured to form a first working environment for restarting the interrupted work on the basis of the first working environment information in the information processing apparatus possessed by the moving body, if the user moves to a destination by the moving body after the user interrupts the work to be interrupted.

2. The work support system according to claim 1, wherein:
the work information in relation to the interrupted work includes predetermined information for instructing the user to restart the interrupted work in the moving body during a period until the user moves to the destination by the moving body; and
the former forms the first working environment in the information processing apparatus so that the user can restart the interrupted work in the moving body in accordance with the predetermined information.

3. The work support system according to claim 1, further comprising a retainer configured to retain second working environment information in order that a second working environment, which is formed in the information processing apparatus in relation to the interrupted work, is formed in another information processing apparatus which is correlated with the destination and which can be accessed by the user, if the interrupted work is not completed when the moving body arrives at the destination.

4. The work support system according to claim 1, wherein the former forms the first working environment in the information processing apparatus so that the user can make communication with another person in charge or a plurality of other persons in charge via the information processing apparatus, if the interrupted work is a work which is to be executed by the user together with the another person in charge or the plurality of other persons in charge.

5. The work support system according to claim 1, wherein:
the work management apparatus also stores work information in relation to a work to be executed by the user other than the interrupted work; and
the work support system further comprises an adjuster configured to notify a user terminal or user terminals of another person in charge or a plurality of other persons in charge who is/are in charge of a collaborative work, of an adjustment request for adjusting a schedule of the collaborative work, if the collaborative work, which is to be executed by the user together with the another person in charge or the plurality of other persons in charge after the work to be interrupted is interrupted, is stored in the work management apparatus.

6. The work support system according to claim 1, further comprising an information presenter configured to present information desired by the user, depending on a reason why the user has interrupted the work to be interrupted.

7. A work support method for supporting work execution by a user by using an information processing apparatus in a moving body which has the information processing apparatus, the work support method comprising:
a step of acquiring first working environment information to be used by the user to restart an interrupted work from a work management apparatus for storing work information in relation to the interrupted work, if the user interrupts the work that has been being executed; and
a step of forming a first working environment for restarting the interrupted work on the basis of the first working environment information in the information processing apparatus possessed by the moving body, if the user moves to a destination by the moving body after the user interrupts the work to be interrupted.
